(19) United States
(12) Patent Application Publication
(10) Pub. No.: US 2021/0163000 A1
(43) Pub. Date: Jun. 3, 2021

(54) METHOD AND SYSTEM FOR DISTANCE CONTROL OF A SUBJECT VEHICLE

(71) Applicant: WABCO GMBH, Hannover (DE)

(72) Inventors: Thomas Dieckmann, Pattensen (DE); Ralph-Carsten Luelfing, Garbsen (DE); Oliver Wulf, Neustadt (DE); Stephan Kallenbach, Hannover (DE)

(21) Appl. No.: 17/048,103

(22) PCT Filed: Mar. 22, 2019
(86) PCT No.: PCT/EP2019/057299

§ 371 Date: Oct. 16, 2020

(30) Foreign Application Priority Data
Apr. 18, 2018 (DE) 10 2018 109 235.0

(51) Int. Cl. B60W 30/16; G08G 1/00; G08G 1/16; B60K 31/00; B60W 50/14; B60T 7/12

(52) U.S. Cl. CPC B60W 30/16; G08G 1/22; G08G 1/166; B60K 31/0008; B60W 50/14; B60T 7/12; B60W 2554/803; B60K 2031/0025; B60K 2031/0041; B60W 2050/146; B60W 2540/215; B60W 2554/802; B60K 2031/0016

(57) ABSTRACT

A method for distance control of a subject vehicle in relation to a front vehicle. The method includes setting, by an adaptive cruise control of the subject vehicle, an automatic distance control mode, wherein: a front object in front of the subject vehicle is detected by an environmental detection system of the subject vehicle, the front object is recognized as the front vehicle, and a distance to the front vehicle is regulated to an adaptive cruise control (ACC) target distance. The method further includes establishing that a safe following driving situation is present based on at least one criteria being met. The method additionally includes outputting, to a driver upon establishing that the safe following driving situation is present, a display signal, and setting, upon input of a confirmation signal by the driver, an automatic distance control platooning mode.

### CROSS REFERENCE TO RELATED APPLICATIONS

This application is a U.S. National Phase Application under 35 U.S.C. § 371 of International Application No. PCT/EP2019/057299, filed on Mar. 22, 2019, and claims benefit to German Patent Application No. DE 10 2018 109 235.0, filed on Apr. 18, 2018. The International Application was published in German on Oct. 24, 2019 as WO 2019/201555 A1 under PCT Article 21(2).

### FIELD

The invention relates to a method for distance control of a subject vehicle and to an adaptive cruise control.

### BACKGROUND

The fuel consumption of utility vehicles, in particular trucks, is substantially determined by the air resistance, in particular on longer trips at uniform velocity. A zone having turbulence and lower air pressure, which zone is also referred to as a slipstream, forms behind a truck. If a following vehicle travels sufficiently close behind the front vehicle, the fuel consumption of the rear vehicle thus decreases; however, in the case of trucks having a travel velocity of, for example, 80 to 100 km/h, distances of significantly less than the typical safety distance of, for example, 50 m are necessary for this purpose, but a sufficiently large safety distance is necessary so that the rear vehicle can brake sufficiently quickly, for example, in the event of abrupt braking of the front vehicle.

Autonomous adaptive cruise controls (ACC) are used as comfort systems and generally have an environmental detection system, for example, a radar device, to consistently control a distance to the front vehicle by autonomous braking interventions and also engine interventions. As comfort systems, the maximum deceleration and the braking ramps, i.e., the change over time of the deceleration, are limited. However, the distances provided for this purpose are too large to enable slipstream driving of a rear vehicle.

Furthermore, AEBS (Advanced Emergency Brake Systems) are known, which engage as emergency braking systems if an accident is immediately imminent and probably can no longer be prevented by the driver alone. For an AEBS, an AEBS cascade is provided, according to which firstly a first warning is output, for example, optically, acoustically, or haptically, before the emergency braking, for example, at least 1.4 seconds before. In this way, the driver is given the opportunity to react thereto; the driver can thus, for example, depending on the traffic situation, initiate an evasive maneuver and change the lane, or initiate braking himself. After the first warning, partial braking can be initiated. Shortly before the emergency braking, a second warning is output and then the full braking, i.e. at full brake pressure, is initiated as emergency braking.

In platooning systems or systems for initiating automated convoy driving (column driving), two or more vehicles have a data connection to one another (V2V, vehicle-to-vehicle communication). The vehicles of the group or convoy can communicate with one another in this way, so that, for example, the front vehicle at once communicates an immediately imminent or initiated braking to the rear vehicles, and therefore the rear vehicles do not first have to detect the braking process of the front vehicle, but rather can immediately initiate a corresponding braking process, in particular using brake pressures and/or target decelerations adapted to one another. Such platooning systems permit very low distances of, for example, 15 m to the respective front vehicle and thus a significant fuel saving. However, they presume a corresponding V2V data connection between the vehicles having standardized command sets, wherein the technical equipment, for example, the state of the brakes, also has to be sufficiently adapted.

### SUMMARY

In an embodiment, the present invention provides a method for distance control of a subject vehicle in relation to a front vehicle. The method includes setting, by an adaptive cruise control of the subject vehicle, an automatic distance control mode, wherein: a front object in front of the subject vehicle is detected by an environmental detection system of the subject vehicle, the front object is recognized as the front vehicle, and a distance to the front vehicle is regulated to an adaptive cruise control (ACC) target distance. The method further includes establishing that a safe following driving situation is present based on at least one of the following criteria being met: the front vehicle is a moving object, the front vehicle is tracked over at least a minimum following period, the front vehicle is tracked in a minimum following period, the distance to the front vehicle is within a predetermined distance range, or a relative velocity is within a predetermined velocity tolerance range. The method additionally includes outputting, to a driver upon establishing that the safe following driving situation is present, a display signal, and setting, upon input of a confirmation signal by the driver, an automatic distance control platooning mode. The automatic distance control platooning mode has a shorter target distance than the ACC target distance of the automatic distance control mode.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a side view of a column made up of two vehicles with a front vehicle and a subject vehicle in a top view;

FIG. 2 shows the corresponding illustration with a merging vehicle;

FIG. 3 shows a block diagram of a control system according to an embodiment;

FIG. 4 shows a flow chart of a method according to an embodiment;

FIG. 5 shows time diagrams of the velocities and accelerations in the ACC mode and in the ACC-P mode;

FIG. 6 shows time diagrams of the velocities and accelerations in the AEBS mode and in the ACC-P mode; and

FIG. 7 shows a design modified in relation to FIG. 3 having additional CC control unit.

### DETAILED DESCRIPTION

Problems occur in the typical environmental detection systems based on radar detectors or radar measuring devices. Radar systems can incorrectly recognize objects which are fundamentally traversable as stationary obstacles (for example, bridges). Foliage or paper on the road can also be incorrectly recognized as a collision-causing stationary object. As a result, limits are placed on expansions of ACC or AEBS systems.

The present disclosure therefore provides a method for distance control and an adaptive cruise control for a subject vehicle, which enable a high level of safety and the possibility of economical driving with low fuel consumption.

A method according to the disclosure can be carried out in particular using an adaptive cruise control; an adaptive cruise control according to the disclosure can, in particular, use a method according to the disclosure.

An adaptive cruise control of the vehicle, upon detecting a front object using its environmental detection system, in particular a radar device, automatically checks whether the conditions are met to initiate a distance control method at reduced distance. Such a distance control method having reduced distance or ACC-P takes place here without data connection to a front vehicle, i.e., it does not represent a platooning system. Accordingly, only a first safety distance is advantageously also set, which is significantly greater than the safety distances possible with platooning systems.

However, changes are performed in relation to an ACC system, said changes being provided, on the one hand, upon initiation as selection criteria, in order to select only suitable front vehicles; furthermore, changes in relation to a conventional ACC are advantageously provided in the control interventions.

The adaptive cruise control having reduced distance thus represents an ACC-platooning mode or ACC-P mode or ACC-P as an adaptive cruise control having reduced safety distance without a data connection to the front vehicle.

The following are provided in particular as suitable criteria or selection criteria: the environmental detection system, in particular the radar device of the vehicle, detects a moving object in front of the subject vehicle. In particular when a radar device is used, significant advantages are thereby afforded, since the radar system limits relate to stationary objects in particular and spurious detections generally do not occur in the case of moving objects.

According to a further criterion, the front vehicle is tracked at least for a minimum time or minimum tracking time, for example, having an object lifetime >30 s. It is thus possible in an automated manner to recognize that the front vehicle is carrying out correspondingly uniform, calm driving, which is sufficient for forming a convoy-type system.

According to a further criterion, the relative velocity or differential velocity between the front vehicle and the subject vehicle is sufficiently low or close to 0 m/s, as a result of which convoy-type driving is again ensured.

According to a further criterion, the distance between the front vehicle and the subject vehicle is sufficiently constant, i.e., for example, a change of the distance is less than a distance limiting value, as a result of which convoy-type driving is again ensured.

Furthermore, supplementary criteria or selection criteria can be provided. It is thus possible for the front vehicle to be classified, wherein then a suitable object class can be provided as a criterion, for example, the object class truck, so as not to follow a vehicle which will more likely select a nonmatching driving style. Furthermore, the front vehicle can be detected with respect to its width and/or height. In this case, a criterion which can be set is that the width or height is constant. The vehicle width and/or vehicle height can also be in a suitable range, for example, a vehicle width of 2.5 m. It is also ensured in this way that the slipstream produced by the front vehicle matches with the subject vehicle, since when following another object, for example, a passenger vehicle, no relevant fuel saving can be anticipated and instead again it is rather more possible for the front vehicle to be driven less calmly or unsuitably, which can only raise safety problems.

According to a further criterion, it can be provided that the ACC is already switched on in the subject vehicle. However, it can also be provided that the environmental detection system already checks whether ACC-P is possible even when the ACC is not yet switched on.

As soon the subject system or the ACC control unit of the adaptive cruise control has established that the designated criteria are met, it preferably first gives a notification to the driver, for example, optically, but also, for example, acoustically or haptically. In this way, the driver is asked whether he wishes to select the ACC-P mode. If the driver gives a confirmation signal in response to said display signal or query signal, for example, by pressing a button in the dashboard, to the ACC control unit, the latter thus subsequently starts the ACC-P mode.

Different settings are then set in the ACC-P mode in relation to a conventional ACC. The safety distance or control distance to the front vehicle is thus shortened in particular.

The ACC-P also has differences in relation to an AEBS. Thus, the provided AEBS cascade made up of warning-partial braking-full braking is advantageously shortened and can enable solely warning-full braking or also braking directly, for example, as partial braking or also full braking, since the entire autonomous braking process is already initiated from a reduced distance and thus time is not unnecessarily lost by the driver warning and reaction of the driver, which is problematic at the reduced control distance. Therefore, in spite of the short distance in the case of the ACC-P, a high level of safety can be ensured. However, a supplementary driver warning is preferably provided at least upon initiating emergency braking or full braking.

It can thus be provided in the ACC that a first target distance or safety distance and a subsequent, lesser safety distance are to be provided, wherein the ACC “plunges” into the first target distance until the second target distance or second safety distance is reached, which then represents an absolute limit. In contrast, in the ACC-P mode, no such division is provided, since the reduced target distance is already sufficiently close to the second safety distance.

In particular, the AEBS cascade already mentioned above can be reduced to direct braking, for example, to direct emergency braking. However, a driver warning is advantageously additionally provided in this case to inform the driver about the initiated emergency braking.

Furthermore, the cruise control function, i.e. a cruise control mode CC is preferably already set in the ACC mode ACC. A set velocity or target velocity is thus specified by the CC mode. The ACC mode ACC additionally set to the CC mode thus only restricts the engine torque, but does not increase the latter. In contrast, according to one advantageous embodiment, the ACC-P mode—in contrast to the ACC mode—can also actively request a higher engine torque than the CC-mode. In particular, separate control units can be provided for this purpose: the CC control unit gives engine request signals to the engine controller, and the ACC control unit limits only the engine torque in the ACC mode, but said ACC control unit can also request higher engine torques in the ACC-P mode. The advantage of an additional CC control unit in addition to the ACC control unit is that said control units can be installed modularly in the vehicle. A high level of flexibility is thus achieved.

This can take place directly according to one design, i.e. the ACC control unit has the option in the ACC-P mode of requesting a higher power via an engine request signal in the engine controller. According to a second embodiment alternative thereto, the ACC control unit sends an engine request signal to the CC control unit, which then optionally sends an engine request signal to the engine controller. According to a third embodiment, the ACC controller in the ACC-P mode, upon recognizing that the limiting of the engine torque is not sufficient to catch up sufficiently close to the front vehicle in the ACC-P mode, gives a display signal to the driver that he should increase the set velocity or target velocity of the CC; the driver thus enables the increase of the engine torque.

Furthermore, in the ACC-P mode, the maximum deceleration is advantageously significantly increased in relation to the ACC, for example, from 2.5 m/s² to 7.5 m/s². According to a further advantageous design, more severe controls of the ACC-P are provided in comparison to the ACC, for example, steeper braking ramps, i.e. changes over time of the target decelerations, a braking ramp of 2.5 m/s³ can thus be set to double that or more, for example, so that the exerted acceleration is also increased faster—in relation to the absolute value.

Emergency braking is thus also automatically achieved faster, comparably to the sudden pressing of the brake pedal for full emergency braking.

Furthermore, in the ACC-P—in contrast to the ACC—a higher deceleration can be requested than that of the front vehicle, to keep the distance constant or also increase it in this way. Thus, for example, it can also be provided that, upon recognition of a deceleration of the front vehicle, a greater deceleration of the subject vehicle is intentionally set. This is based on the consideration that, owing to the measurement principle of the environmental detection system, for example, a radar device, firstly the front vehicle has to decelerate first so that the environmental detection system of the following vehicle measures this deceleration and reacts thereto. During a braking process or deceleration process of the front vehicle, the following vehicle would thus initially react with a time delay in each case, so that even with identical deceleration of both vehicles, a continuous distance reduction can occur. By the following vehicle intentionally requesting a higher target deceleration upon recognition of a deceleration process of the front vehicle, such a continuous distance reduction can be prevented.

The ACC control unit can in principle request in the ACC-P mode—as in the conventional ACC mode or also like an AEBS—target values by way of request signals or control signals at the engine control unit and the brake control unit, for example, a target deceleration or a target acceleration torque. A conventional ACC generally attempts to use the sustained-action brakes or retarder of the vehicle to keep the wear of the service brakes (deceleration) low. However, this control strategy is advantageously changed in the ACC-P mode. It can thus be provided that the sustained-action brakes are not used at all, or the sustained-action brake is requested only for lower target decelerations.

The ACC-P mode is advantageously immediately ended when one of the criteria is no longer met. It is also immediately ended when a merging process of a vehicle from an adjacent lane is recognized. If the merging driving object is then detected by the environmental detection system, the above-mentioned criteria thus firstly have to be met again so that the ACC-P mode is proposed to the driver.

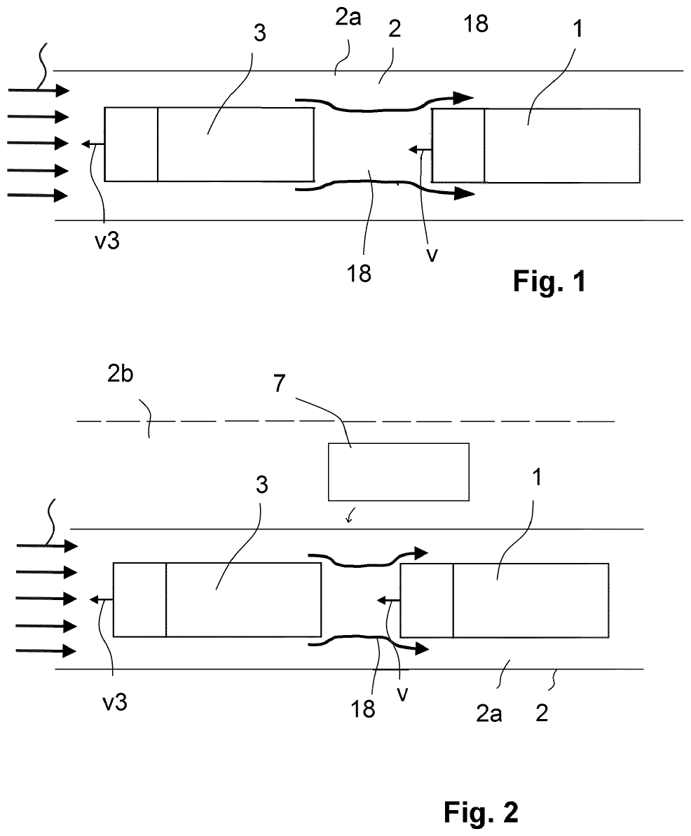

A subject vehicle 1 drives on a roadway (road) 2, according to the top view of FIG. 2 on a separate lane 2a. A front vehicle 3 drives in front of the subject vehicle 1, which front vehicle does not have a data connection or a data connection with autonomous transmission of driving dynamics data and/or control signals for vehicle interventions, in particular braking processes, to the subject vehicle 1.

The subject vehicle 1 has as the first environmental detection system a radar device 4, using which a distance d to a front object 3 can be detected. In addition, the subject vehicle 1 can also have yet further environmental detection systems, for example, a camera 5, which is not required in principle, however. The subject vehicle 1 furthermore has an adaptive cruise control 8, which has the first environmental detection system 4 and an ACC control unit 10, wherein the ACC control unit 10 of the adaptive cruise control 8 records first measurement signals Si and outputs engine request signals S2 to an engine control unit 12 to activate a vehicle engine, and brake request signals S3 to a brake control unit 14 to activate, on the one hand, service brakes (friction brakes) 15 and furthermore a retarder (non-wearing brake, sustained-action brake) 16.

The ACC control unit 10 can set various modes. Thus, a normal driving mode M0 can be present, and an autonomous distance control mode ACC can be set, in which the environment is detected in a known manner via at least the first environmental detection system, i.e. the radar device 4, and possibly also via the camera 5, so that a constant spatial distance d and/or time interval dt at constant differential velocity Δv=0 can be set between the front vehicle 3 and the subject vehicle 1, i.e. as an autonomous distance keeping system.

In principle, the adaptive cruise control 8 can additionally also have a platooning mode, in which it exchanges signals with further vehicles, for example, the front vehicle 3. In the method described hereinafter, however, no data transfer takes place with the front vehicle 3, to set a short distance d by way of such a platooning system.

Furthermore, the adaptive cruise control 8 can have an AEBS as an autonomous emergency braking method, so that, upon recognition of an emergency braking situation, the AEBS cascade made up of driver warning, partial braking, and emergency braking is automatically initiated. The AEBS can also be initiated automatically from an ACC mode in particular.

A slipstream or drag zone 18 arises behind the front vehicle 3, in which fundamentally turbulence and a slight negative pressure arise. The subject vehicle 1 experiences either the normal travel wind 21 or additional turbulence in the normal driving mode MO and also in the ACC mode ACC, but does not enter the drag zone 18, to achieve slipstream driving with reduced fuel consumption in this way.

The ACC control unit 10 is furthermore designed to pass from the normal ACC into an automated distance control platooning mode ACC-P.

The ACC control unit 10 can thus set a normal driving mode MO, an ACC mode ACC, and the automatic distance control platooning mode, abbreviated ACC-P mode, ACC-P.

In this case, the ACC control unit 10 sets the ACC-P if it recognizes according to the flow chart of FIG. 4 that the criteria (decision criteria) K1 to at least K5 are met. In this case, a following driving situation FS with respect to the front vehicle 3 is to be recognized in particular, which ensures sufficient safety. After the start St0, measurement signals S1 are thus recorded via the first environmental detection system in step St1. The following criteria are then evaluated in step St2:
First criterion K1: the radar device 4 detects as the front object a front vehicle 3, i.e., a moving object: the effect also achieved by this means, in particular, is that the radar system limits, which are problematic in the case of stationary objects, for example, the incorrect recognition of nonrelevant objects such as bridges and, for example, also dirt, paper, or road edges, can be excluded as distance objects. The knowledge is taken into consideration here that the detection of moving objects by a radar device 4 is very reliable.
Second criterion K2: furthermore, the front vehicle 3 is continuously detected over at least one minimum following period t_min,
Third criterion K3: the same object is always detected as the front vehicle 3, i.e. no changing objects.
Fourth criterion K4: the ACC control unit 10 furthermore recognizes that the subject vehicle 1 drives at an approximately constant spatial distance d or time interval dt in relation to the front vehicle 3. In this case, approximately constant is selected, for example, to be a following distance range of Δd_lim of ±1 m, or as a following time interval range Δt_lim of 0.1 seconds, i.e. with high consistency.
Fifth criterion K5: furthermore, the ACC control unit 10 recognizes that a relative velocity Δv=v1−v3, i.e. the difference of the inherent velocity of the subject vehicle to the velocity of the front vehicle 3 is approximately 0, i.e., for example, in a distance range of ±0.1 m/s. Approximately constant driving is thus present.

Further criteria can also be used in this case, for example, the following criteria:
sixth criterion K6: the front vehicle 3 can be classified in a classification of vehicle types which does not change at least during the minimum following period (tₘᵢₙ). In this case, a classification in an applicable vehicle class is recognized, in particular as a truck. Other vehicle types such as passenger vehicle, tractors, etc. are not to be used in this case for safety reasons.
Seventh criterion K7: an object width b3 of the front vehicle 3 is within a permissible range,
eighth criterion K8: the object width b3 of the front vehicle 3 is constant within a measurement accuracy,
ninth criterion K9: a relative transverse velocity (Δvy) of the front vehicle 3 in relation to the subject vehicle is less than a transverse velocity limiting value (Δvy_tres),
tenth criterion K10: an object height h3 of the detected front vehicle 3 is within a permissible range,
eleventh criterion K11: the object height h3 is constant within a measurement accuracy.
In particular, the twelfth criterion K12 can be provided: the ACC is already active before an ACC-P is offered. The ACC-P is thus only offered from the safe ACC, in which an ACC target distance d_ACC is therefore already autonomously regulated.
Thirteenth criterion K13: the spatial distance d and/or the time interval dt with respect to the front vehicle 3 is sufficiently constant. For this purpose, it can be checked, for example, whether a change over time dd of the spatial distance d and/or a change over time ddt of the time interval dt is less than a distance limiting value d_tres.

As soon the ACC control unit 10 thus recognizes that the required criteria K1 to K5 and possibly further criteria are met, it suggests, according to branch y in step St3, the ACC-P mode ACC-P, by outputting a query signal or display signal S4 at a display unit 22, for example, in the dashboard region of the driver. If the driver, in step St4 according to branch y, confirms this display by a confirmation signal S5, for example, by pressing a corresponding actuating unit 23 or a pushbutton, the ACC control unit 10 will subsequently set the ACC-P mode ACC-P upon receiving the confirmation signal S5 according to step St5 and for this purpose will correspondingly output request signals S2, S3 to the engine control unit 12 and to the brake control unit 14.

In the ACC-P mode ACC-P, the ACC control unit 10 automatically regulates the ACC target distance d_ACC by outputting engine request signals S2 and brake request signals S3.

More abrupt braking actions are permissible in ACC-P. Thus, for example, in the ACC-P mode ACC-P, a maximum ACC deceleration is increased from the ACC value 2.5 m/s², for example, to 7.5 m/s², i.e. significantly more abrupt braking actions are permissible. A severity control also takes place in such a way that the ACC braking ramps are set steeper or faster in the ACC-P mode ACC-P, i.e. as higher changes over time of the deceleration, in m/s³.

Furthermore, the brake control unit 14 is activated in such a way that the priorities of conventional braking are changed in the ACC mode:

In the ACC mode ACC, the sustained-action brake or retarder 16 is given priority over the service brakes 15 to keep the brake wear low. In contrast, this priority is dispensed with in the ACC-P mode ACC-P, and therefore here owing to greater safety and faster effectiveness, the service brakes 15 are preferably activated.

The engine control unit 12 is accordingly activated using different parameters. The engine limit can thus be reduced in the ACC-P mode ACC-P, and therefore in the context of the set ACC-P target velocity, the vehicle drives at correspondingly equal velocity as the front vehicle 3.

The ACC-P mode ACC-P is advantageously ended in this case by the ACC control unit 10 if at least the basic criteria K1 to K5, or also all criteria set at the beginning are no longer met.

In particular upon merging of the third object 7 from a further lane 2b between the front vehicle 3 and the subject vehicle 1, the ACC-P mode ACC-P can be ended immediately. The subject vehicle 1 subsequently then follows the third object 7 which has merged in between and can switch on the ACC-P mode ACC-P again only after meeting the criteria K1 to K5.

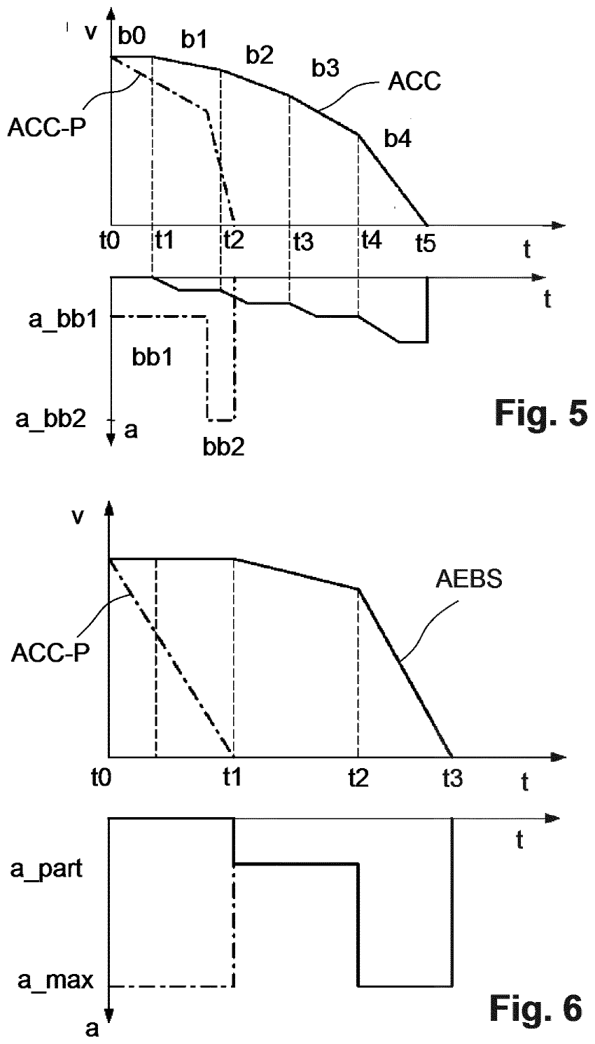

FIG. 5 shows a braking process in the ACC mode and in the ACC-P mode in each case as a time diagram of the velocity v and the acceleration a, which is plotted here downward or in the negative range, since decelerations, i.e. negative accelerations, are present. FIG. 6 accordingly shows such a comparison between the AEBS mode and the ACC-P mode.

In FIG. 5, the front vehicle 3 decelerates strongly or performs emergency braking at the time t0. The radar device 4 also detects this; however, a strong deceleration is not immediately executed in the ACC mode, but rather the ACC control unit 10 firstly limits at a first time t1 the engine torque MM, then requests the first retarder 16 from the brake control unit 14 at a second time t2 and—if provided—a second retarder later at a third time t3, and the service brakes 15 only in the fourth step at a fourth time t4. All of these requests are executed in the form of ramps for reasons of comfort, so that the starting phase b0 (after detection of the braking process of the front vehicle 3) and the four braking phases b1, b2, b3, b4 of the ACC result after the first to fourth times t1 to t4.

The ACC-P or the ACC-P mode can in particular immediately upon recognizing a deceleration of the front vehicle 3, firstly in a retarder braking phase bbl. request a maximum (i.e. full) braking torque M16_max from the retarder 16 or also the multiple retarders/sustained-action brakes, also without ramps, i.e., suddenly at an acceleration value a_bb1. In a subsequent service brake phase bb2, the ACC-P can suddenly request maximum (i.e. full) deceleration a_bb2 from the service brakes 15, if the situation is identified as extremely critical. However, the ACC-P can also immediately request full deceleration a_bb2 from the service brakes 15, see the following comparison of FIG. 6.

According to FIG. 6, the radar device 4 again detects at a (start) time t0 that the front vehicle 3 is strongly decelerating or performing emergency braking. The ACC control unit 10 does not carry out emergency braking immediately in the AEBS mode. Certain criticality criteria KK first have to be met, i.e. it has to be sufficiently critical, then first the first warning comes at the first time t1, then the second warning at the second time t2, which is accompanied by a partial braking apart and then the full braking a_max.

In the ACC-P mode, in contrast, the ACC control unit 10 can immediately carry out emergency braking or full braking at a_max according to the dot-dash line, i.e., from the (start) time to, as soon as a strong deceleration a3>a3_tres of the front vehicle 3 is recognized.

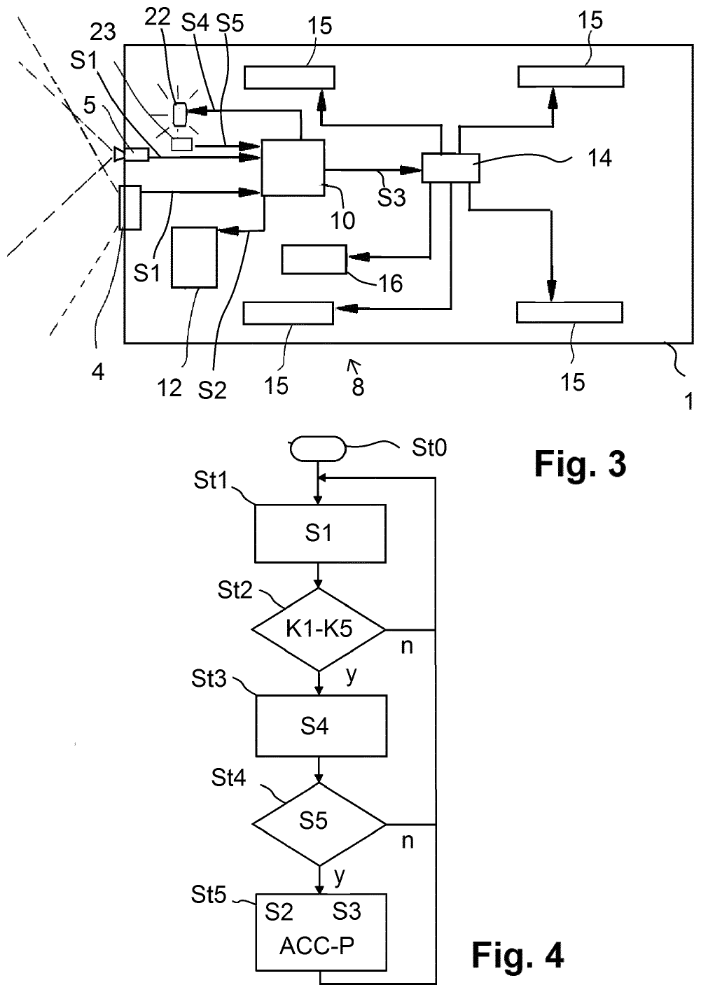

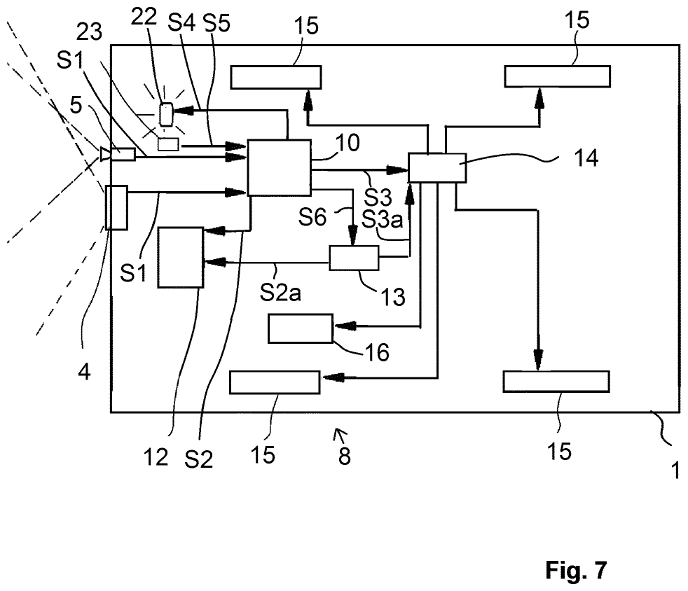

FIG. 7 shows an embodiment modified in relation to FIG. 3, in which a CC control unit 13 is installed in the subject vehicle 1, which CC control unit executes a cruise control function and is activated in each case before the setting of an ACC mode. The CC control unit 13 thus outputs engine request signals S2a and brake request signals S3a to the control units 12, 14. In this case, the ACC control unit 10 and the CC control unit 13 are often supplied by different producers. In the ACC mode, there is no communication from the ACC control unit 10 to the CC control unit 13.

If the ACC control unit 10 recognizes that the present maximum engine torque is not sufficient so that in the ACC-P mode the subject vehicle 1 can catch up to the front vehicle 3, various embodiments can thus be provided to request a higher maximum engine torque: according to a first embodiment for this purpose, the ACC control unit 10 can request a higher power, i.e. a higher maximum engine torque directly at the engine controller 12 via an engine request signal S3.

According to a second embodiment, the ACC control unit 10 can output engine torque request signals S6 in the ACC-P mode to the CC control unit 13, so that the CC control unit 13 requests a higher engine torque via an engine request signal S2a, and therefore the subject vehicle 1 can catch up to the front vehicle 3.

According to a third embodiment, the ACC control unit 10 outputs in the ACC-P mode, upon recognizing that the limiting of the engine torque is not sufficient to catch up close enough to the front vehicle 3 in the ACC-P mode, a display signal S4 to the driver that he should increase the set velocity or target velocity of the CC; the driver thus enables the increase of the engine torque at the CC control unit 13, which outputs an engine request signal S2a for a higher maximum engine torque.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 subject vehicle

2 roadway, road

2a own lane

3 front object, in particular front vehicle

4 first environmental detection system, radar device

7 third object

8 adaptive cruise control

10 ACC control unit

12 engine control unit

13 CC control unit

14 brake control unit

15 service brakes

16 retarder, sustained-action brake

22 display unit

23 actuating unit

ACC distance control mode or adaptive cruise control

ACC-P distance control platooning mode

d spatial distance of the subject vehicle 1 in relation to the front vehicle 3

dt time interval of the subject vehicle 1 in relation to the front vehicle 3

d_ACC ACC target distance

d_P ACC-P target distance

Δd_lim spatial distance range

Δt_lim time interval range

Δd_ACC-P target spatial distance of the ACC-P

Δt_ACC-P target time interval of the ACC-P

ddt, dd change over time of the time interval dt

ddt, dd change over time of the spatial distance d

d_tres distance limiting value

t0 (start) time

t1 first time

t2 second time

t3 third time

Δvy_tres transverse velocity limiting value

Δvy relative transverse velocity

Δv relative velocity

FS safe following driving situation

S1 measurement signals

S2 engine request signal

S3 brake request signal

S4 query signal to the driver

S5 confirmation signal by the driver

S6 engine torque request signal

S2a engine request signal of the CC control unit 13

S3a engine request signal of the CC control unit 13

K1 to K12 decision criteria

1. A method for distance control of a subject vehicle in relation to a front vehicle, the method comprising:
setting, by an adaptive cruise control of the subject vehicle, an automatic distance control mode, wherein:
a front object in front of the subject vehicle is detected by an environmental detection system of the subject vehicle,
the front object is recognized as the front vehicle, and
a distance to the front vehicle is regulated to an adaptive cruise control (ACC) target distance,
establishing that a safe following driving situation is present based on at least one of the following criteria being met:
the front vehicle is a moving object,
the front vehicle is tracked over at least a minimum following period,
the front vehicle is tracked in a minimum following period,
the distance to the front vehicle is within a predetermined distance range, or
a relative velocity is within a predetermined velocity tolerance range,
outputting, to a driver upon establishing that the safe following driving situation is present, a display signal, and
setting, upon input of a confirmation signal by the driver, an automatic distance control platooning mode, wherein the automatic distance control platooning mode has a shorter target distance than the ACC target distance of the automatic distance control mode.

2. The method as claimed in claim 1, wherein one or more of the following criteria are additionally provided to recognize a safe following driving situation:
the front vehicle-4) is classified in a permissible object class that does not change during the minimum following period,
an object width of the front vehicle is within a permissible range,
the object width is constant within a measurement accuracy,
a relative transverse velocity of the front vehicle in relation to the subject vehicle is below a transverse velocity limiting value,
an object height of the detected front object is within a permissible range,
the object height is constant within a measurement accuracy, or
a change over time of the distance to the front vehicle is less than a distance limiting value.

3. The method as claimed in claim 1, wherein establishing that a safe following driving situation is present is further based on the automatic distance control mode already being switched on.

4. The method as claimed in claim 1, wherein the environmental detection system has a distance measuring system for determining the distance to a front object.

5. The method as claimed in claim 1, wherein by additionally using a second environmental detection system an unambiguous identification of the front vehicle is carried out, and/or the object class is determined.

6. The method as claimed in claim 1, wherein the display signal is displayed in an optical display unit in a vehicle cab and the driver inputs the confirmation signal to set the autonomous distance control platooning mode as a haptic input during the display of the display signal.

7. The method as claimed in claim 1, wherein, if the distance control platooning mode is set and subsequently one of the criteria is not met, the distance control platooning mode is ended and a switch is made into the automatic distance control mode.

8. The method as claimed in claim 1, wherein, in the automatic distance control platooning mode, greater maximum vehicle decelerations and/or steeper braking ramps are provided with respect to an absolute value than in the automatic distance control mode.

9. The method as claimed in claim 1, wherein in the automatic distance control mode, a first control strategy is provided for preferred use of a wear-free retarder brake over a service brake, and
wherein in the automatic distance control platooning mode, a second brake control strategy is provided without preferred use of a wear-free retarder brake and/or without use of a wear-free retarder brake.

10. The method as claimed in claim 1, wherein, in the automatic distance control mode, an equal deceleration of the subject vehicle as a detected front vehicle deceleration is provided, and
wherein, in the automatic distance control platooning mode, a deceleration of the subject vehicle greater in absolute value than the detected front vehicle deceleration is provided, to avoid an approach due to deceleration values increasing over time.

11. The method as claimed in claim 1, wherein the automatic distance control mode has a temporal and/or spatial ACC target distance and a lesser minimum distance, which it is not permitted to fall below, and
wherein the automatic distance platooning mode does not have an additional minimum distance.

12. The method as claimed in claim 1, wherein an autonomous emergency braking system mode is further provided having an AEBS cascade for successively initiating a first driver warning, a partial braking, and an emergency braking before an accident, and
wherein, in the automatic distance control platooning mode, emergency braking is initiated without the first driver warning and/or without the partial braking.

13. The method as claimed in claim 1, wherein upon recognition that a second detection object has moved between the subject vehicle and the front object, the distance control platooning mode is ended.

14. The method as claimed in claim 1, wherein the subject vehicle and the front vehicle do not transmit, to one another, signals about the initiation of braking processes.

15. The method as claimed in claim 1, wherein in the case that it is recognized that, in the distance control platooning mode, a present maximum engine torque is not sufficient to catch up with the front vehicle, a higher maximum engine torque is requested:
directly by an engine controller,
by outputting an engine torque request signal to an additional cruise control (CC) controller, or
by outputting a display signal to the driver and inputting of a confirmation signal by the driver.

16. An adaptive cruise control system for a subject vehicle, the adaptive cruise control system comprising:
an environmental detection system configured to detect a front environment in front of the subject vehicle,
an adaptive cruise control (ACC) controller configured to record measurement signals of the environmental detection system, and
a display configured to record display signals of the ACC controller and to output a driver display; and
an actuator configured to be actuated by a driver and to output a confirmation signal to the ACC controller, wherein the ACC controller is configured to carry out the method as claimed in claim 1.

17. The adaptive cruise control as claimed in claim 16, wherein the environmental detection system is a distance recognition system.

18. The adaptive cruise control as claimed in claim 15, further comprising a second controller in addition to the ACC controller,
wherein the ACC controller is configured, in the distance control platooning mode, and upon recognizing that a present maximum engine torque is not sufficient to catch up to the front vehicle, to request a higher maximum engine torque:
directly by an engine request signal to an engine controller,
by outputting an engine torque request signal to the second controller, or
by outputting a display signal to the driver and inputting of a confirmation signal by the driver.
